(19) United States
(12) Patent Application Publication
(10) Pub. No.: US 2024/0126033 A1
(43) Pub. Date: Apr. 18, 2024

(54) OPTICAL AND COPPER COMPOSITE TERMINAL BOX

(71) Applicant: Talentis Corp., Gwangju (KR)

(72) Inventors: Seong Jin YUN, Gwangju (KR); Kyung Su KIM, Gwangju (KR)

(21) Appl. No.: 18/310,168

(22) Filed: May 1, 2023

(30) Foreign Application Priority Data
Oct. 14, 2022 (KR) 10-2022-0131935

(51) Int. Cl. G02B 6/44

(52) U.S. Cl. CPC G02B 6/4446; G02B 6/4448

(57) ABSTRACT

An optical and copper composite terminal box can include a terminal box body, a splitter having a lead-in terminal connectable to any one of a plurality of cores included in an optical cable, and a plurality of output terminals connectable to a plurality of cables. The splitter can be provided on one side in the terminal box body. The terminal box can include a copper cable connection device which is disposed in the terminal box body adjacent to the splitter and is connectable to a copper cable forming a different signal from the optical cable.

### BACKGROUND

### 1. Field of the Invention

The present invention relates to an optical and copper composite terminal box, and more particularly, to an optical and copper composite terminal box that can reduce the occurrence of loss related to construction cost or workability by implementing an optical terminal box and a copper terminal box that have been individually manufactured and installed as one body.

### 2. Discussion of Related Art

Optical terminal boxes are box-shaped products used to protect and distribute optical fiber links in a fiber-to-the-home (FTTH) network. Use of optical terminal boxes has become much more active recently.

However, it is known that asymmetric digital subscriber lines (ADSLs) and very high-bit rate digital subscriber lines (VDSLs) are still used in some rural areas. Therefore, there is a problem in that, since the telecommunications companies install unshielded twisted pair cable (UTP) copper terminal boxes (copper cable (CC) communication lines) in addition to optical terminal boxes for the above demand, the construction cost is doubled.

### RELATED ART DOCUMENT

### Patent Document

(Utility Model Document 0001) Korean Unexamined Utility Model Registration Application Publication No. 20-2011-0005159 (Published on May 25, 2011)

### SUMMARY OF THE INVENTION

The present invention is directed to providing an optical and copper composite terminal box that can reduce the occurrence of loss related to construction cost or workability by implementing an optical terminal box and a copper terminal box that have been individually manufactured and installed as one body.

According to an aspect of the present invention, there is provided an optical and copper composite terminal box including a terminal box body, a splitter having a lead-in terminal connectable to any one of a plurality of cores included in an optical cable, and a plurality of output terminals connectable to a plurality of cables, and which is provided on one side in the terminal box body, and a copper cable connection device which is disposed in the terminal box body adjacent to the splitter and is connectable to a copper cable forming a different signal from the optical cable.

The optical and copper composite terminal box may further include a splitter case in which the splitter is installed, and a splitter mounting plate in which the splitter case is mounted and which rotates the splitter case by an action of a hinge.

The optical and copper composite terminal box may further include a fusion splicing tray which is provided in the terminal box body at a position corresponding to the splitter mounting plate and in which cables that another core of the plurality of cores included in the optical cable is fused to any one core of a plurality of cores included in another optical cable are disposed.

The optical and copper composite terminal box may further include a slide cover which is slidably coupled to the terminal box body to be opened or closed to cover the splitter and the copper cable connection device.

The optical and copper composite terminal box may further include slide guide rails which are provided on both side surfaces of the terminal box body and guide a sliding operation of the slide cover, and a rotatable cover support which is rotatably coupled to the terminal box body and supports an opened state of the slide cover.

The optical and copper composite terminal box may further include a plurality of cable lead-in parts which are provided on a sidewall of the terminal box body and through which optical and copper cables enter, a plurality of cable holders which are provided on a peripheral support part of the cable lead-in parts and support the optical and copper cables that enter through the cable lead-in parts, and at least one terminal box fixing member provided on a rear surface of the terminal box body.

The copper cable connection device may include a device body having an assembly part that is allowed to be assembled to the terminal box body, copper cable connection parts which are provided on the device body and to which a plurality of copper cables are connected at different positions, and a copper cable disconnection part which is disposed between the copper cable connection parts and connects between the copper cables or disconnects between the copper cables.

Two copper cable connection parts may be used as a set for each copper cable disconnection part, wherein a plurality of copper cable disconnection parts and a plurality of copper cable connection parts may be provided on the device body, and the device body may be provided to be grounded.

The copper cable connection part may include a copper cable connection terminal which is made of a conductive material, and including at least one terminal groove into which a copper cable is inserted, a copper cable holder including a copper cable insertion groove into which the copper cable is insertable without peeling off an outer sheath thereof and which is rotatably coupled to the device body and guides the copper cable to be positioned in the terminal groove of the copper cable connection terminal, and a holder hinge which is connected to the copper cable holder and the device body and guides rotation of the copper cable holder.

The copper cable disconnection part may include a disconnection part terminal which has a non-linear shape and is allowed to selectively connect to or disconnect the copper cable connection terminal at both sides thereof, a disconnection part case which is connected to the disconnection part terminal to form one body with the disconnection part terminal, and is rotatably coupled to the device body, and a disconnection part hinge which is connected to the disconnection part case and the device body and guides rotation of the disconnection part case, wherein, when the disconnection part case is pressed downward, the copper cable connection terminal and the disconnection part terminal may communicate with each other so that the corresponding copper cables may be connected, and when the disconnection part case is operated upward, the connection between the copper cable connection terminal and the disconnection part terminal may be forcibly disconnected.

The optical and copper composite terminal box may further include a copper cable arrangement guide which is coupled to one side of the device body and guides arrangement of the copper cables.

### BRIEF DESCRIPTION OF THE DRAWINGS

In order to more fully understand the accompanying drawings cited in detailed description of the present invention, a detailed description of each drawing is provided.

The above and other objects, features and advantages of the present invention will become more apparent to those of ordinary skill in the art by describing exemplary embodiments thereof in detail with reference to the accompanying drawings, in which:

FIG. 1 is a block diagram of a system including an optical and copper composite terminal box according to an embodiment of the present invention;

FIG. 2 is a schematic cross-sectional view of an optical cable illustrated in FIG. 1;

FIG. 3 is a front view of an optical and copper composite terminal box according to an embodiment of the present invention;

FIG. 4 is a rear view of FIG. 3;

FIG. 5 is a view in which a slide cover in FIG. 3 is opened;

FIG. 6 is a rear perspective view of FIG. 5;

FIG. 7 is a perspective view in which a splitter mounting plate in FIG. 5 is rotated;

FIG. 8 is a view of FIG. 7 from another angle;

FIG. 9 is an enlarged view of a main part of FIG. 8;

FIG. 10 is a front view of a copper cable connection device;

FIG. 11 is a view in which copper cables in FIG. 10 are connected;

FIG. 12 is an enlarged perspective view of region A of FIG. 10;

FIG. 13 is a rear view of FIG. 12;

FIG. 14 is a view in which a copper cable holder and a disconnection part case in FIG. 12 are removed;

FIG. 15 is a layout diagram of copper cable connection terminals and disconnection part terminals;

FIGS. 16 and 17 are views illustrating a process of connecting a copper cable to a copper cable connection device;

FIG. 18 is a view illustrating a grounding structure of a copper cable connection device; and

FIG. 19 is a view illustrating a state in which a copper cable connection terminal and a disconnection part terminal are disconnected.

### DETAILED DESCRIPTION OF EXEMPLARY EMBODIMENTS

A specific structural or functional description of embodiments according to the inventive concept disclosed herein has merely been illustrated for the purpose of describing the embodiments according to the inventive concept, and the embodiments according to the inventive concept may be implemented in various forms and are not limited to the embodiments described herein.

Since the embodiments according to the inventive concept may be changed in various ways and may have various forms, the embodiments are illustrated in the drawings and described in detail herein. However, there is no intent to limit the embodiments according to the inventive concept to the particular forms disclosed. Conversely, the embodiments are to cover all modifications, equivalents, and alternatives falling within the scope of the invention.

In addition, the terms such as “first” or “second” may be used to describe various elements, but these elements are not limited by these terms. These terms are used to only distinguish one element from another element. For example, a first element could be termed a second element, and, similarly, a second element could be termed a first element without departing from the scope of the inventive concept.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, other expressions describing the relationships between elements should be interpreted in the same way (e.g., “between” versus “directly between,” “adjacent” versus “directly adjacent,” etc.).

The terms used herein are merely set forth to explain the embodiments of the present invention, and the scope of the present invention is not limited thereto. As used herein, the singular forms are intended to include the plural forms as well, unless the context clearly indicates otherwise. It should be further understood that the terms “comprises,” “comprising,” “includes,” “including,” “has” and/or “having,” when used in this specification, specify the presence of stated features, integers, steps, operations, elements, components, or groups thereof but do not preclude the presence or addition of one or more other features, integers, steps, operations, elements, components, or groups thereof.

Unless otherwise defined, all terms (including technical and scientific terms) used herein have the same meaning as commonly understood by those skilled in the art. Generally used terms, such as terms defined in dictionaries, should be construed as having meanings matching contextual meanings in the art. In this description, unless defined clearly, terms are not to be construed as having ideal or excessively formal meanings.

Hereinafter, the present invention will be described in detail by explaining exemplary embodiments of the present invention with reference to the accompanying drawings.

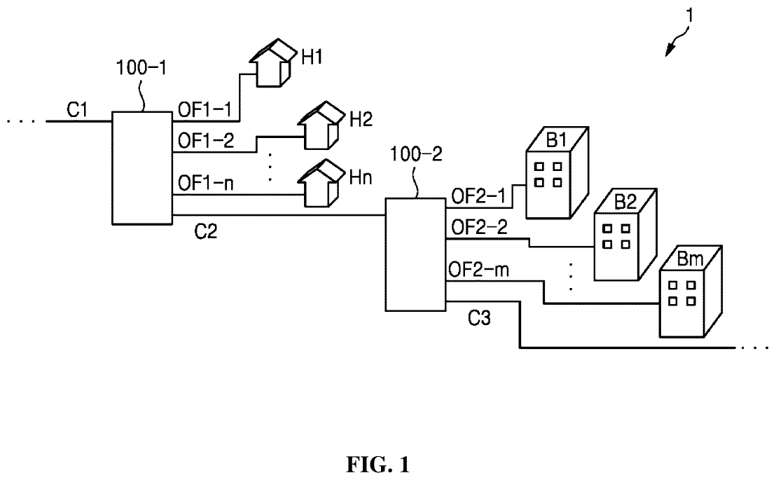

FIG. 1 is a block diagram of a system including an optical and copper composite terminal box according to an embodiment of the present invention.

Referring to FIG. 1, a system 1 includes a plurality of optical and copper composite terminal boxes 100-1, 100-2, . . . . Although two optical and copper composite terminal boxes 100-1 and 100-2 are illustrated in FIG. 1 for convenience of description, the number of optical and copper composite terminal boxes 100-1 and 100-2 may vary according to embodiments.

The optical and copper composite terminal boxes 100-1 and 100-2 are devices used to directly connect optical fibers OF1-1, OF1-2, . . . , OF1-n, and OF2-1, OF2-2, . . . , OF2-m (here, n and m are natural numbers) to houses H1, H2, . . . , Hn (n is a natural number) and buildings B1, B2, . . . , Bm (m is a natural number). The optical fibers OF1-1, OF1-2, . . . , OF1-n, and OF2-1, OF2-2, . . . , OF2-m are directly connected to the houses H1, H2, . . . , Hn and the buildings B1, B2, . . . , Bm, and thus the houses H1, H2, . . . , Hn or the buildings B1, B2, . . . , Bm may perform data communication with another house (not illustrated) or another building (not illustrated). The optical and copper composite terminal boxes 100-1 and 100-2 are generally installed on telecommunications poles.

Meanwhile, the optical and copper composite terminal boxes 100-1 and 100-2 may be connected to each other through optical cables C1, C2, C3, . . . .

The optical cables C1, C2, C3, . . . are used to transmit data at a high speed. The optical cables C1, C2, C3, . . . may be called various terms such as fiber optic cables, optic fiber cables, and the like.

A first optical and copper composite terminal box 100-1 connects a first optical cable C1 and a second optical cable C2 to each other. A second optical and copper composite terminal box 100-2 connects the second optical cable C2 and a third optical cable C3 to each other. The optical and copper composite terminal box 100-1 or 100-2 connects the optical cables C1 and C2 or C2 and C3 to each other, and thus data may be transmitted farther. One end of the optical cable C1 may be connected to the first optical and copper composite terminal box 100-1, and the other end of the optical cable C1 may be connected to another optical and copper composite terminal box (not illustrated). In some embodiments, the optical cables C1, C2, C3, . . . may be optical-power composite cables in which an optical cable and a power cable are combined.

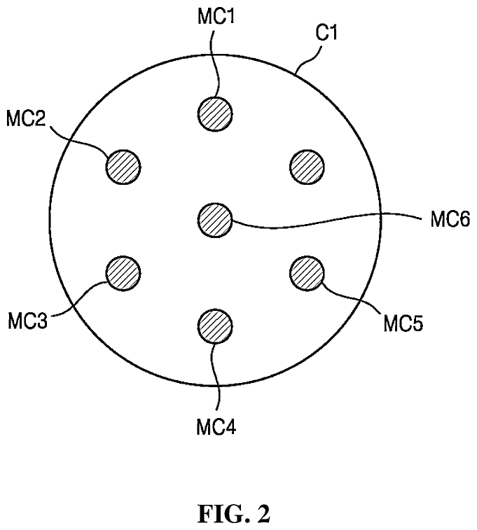

FIG. 2 is a schematic cross-sectional view of the optical cable illustrated in FIG. 1.

Referring to FIG. 2, the optical cable C1 may include a plurality of cores MC1 to MC6. Each of the plurality of cores MC1 to MC6 is a region through which light is transmitted. The number and positions of the plurality of cores MC1 to MC6 may vary according to embodiments. Therefore, the scope of the present invention is not limited by the shape illustrated in the drawing.

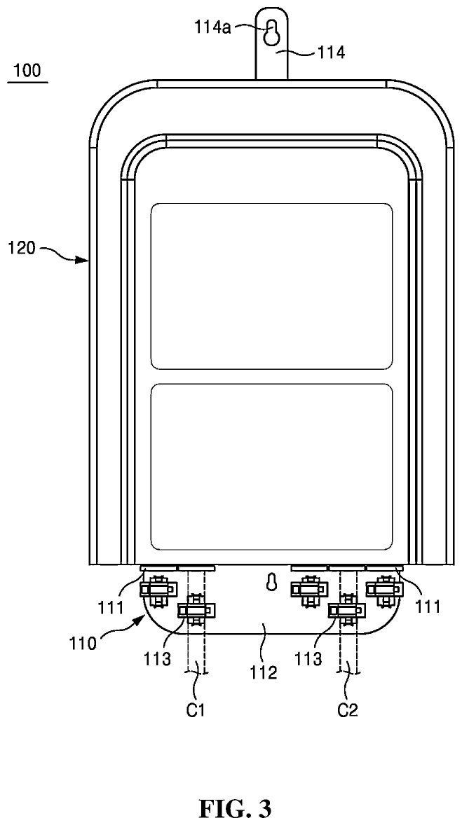

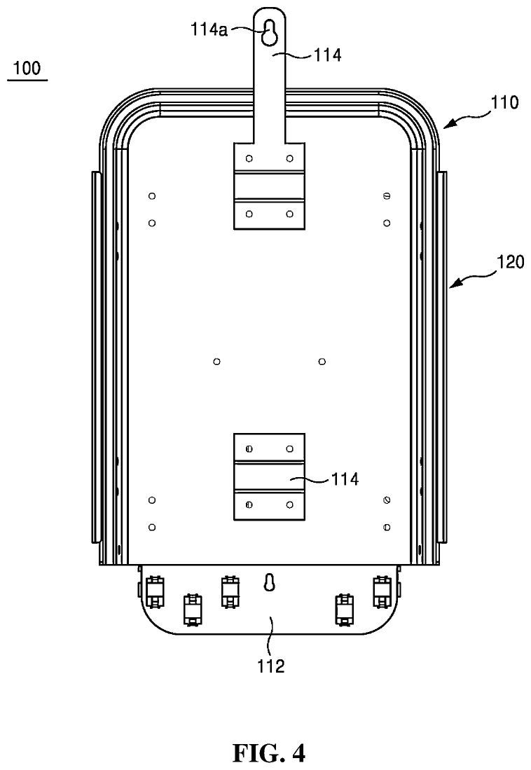

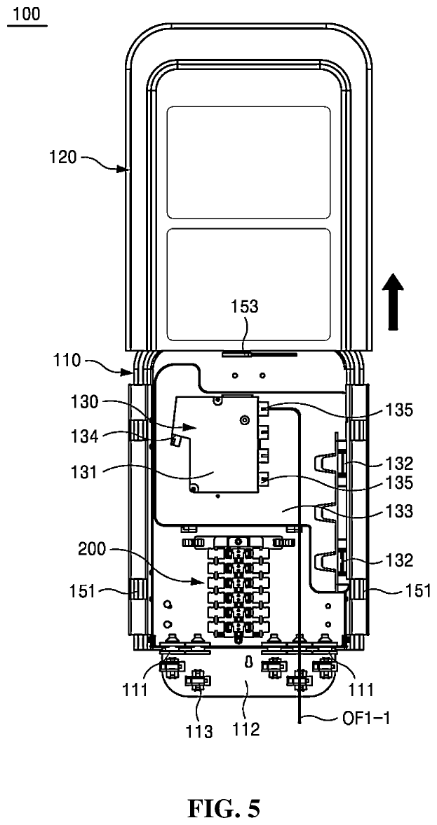

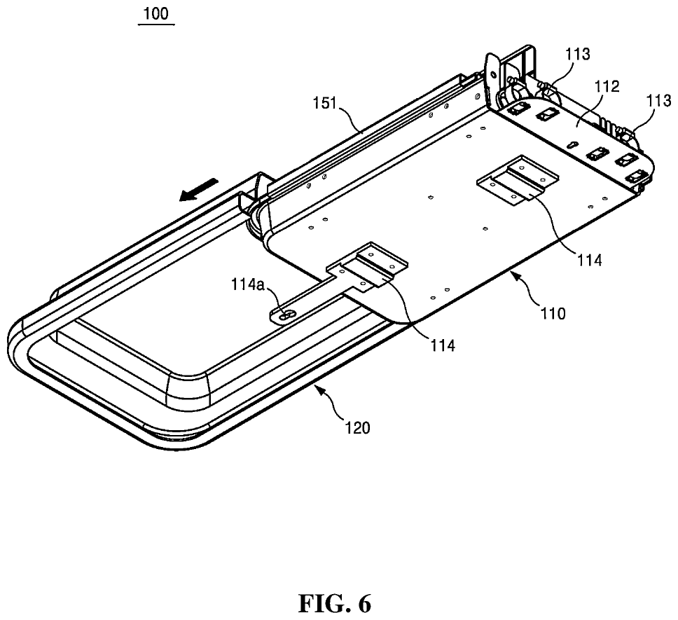

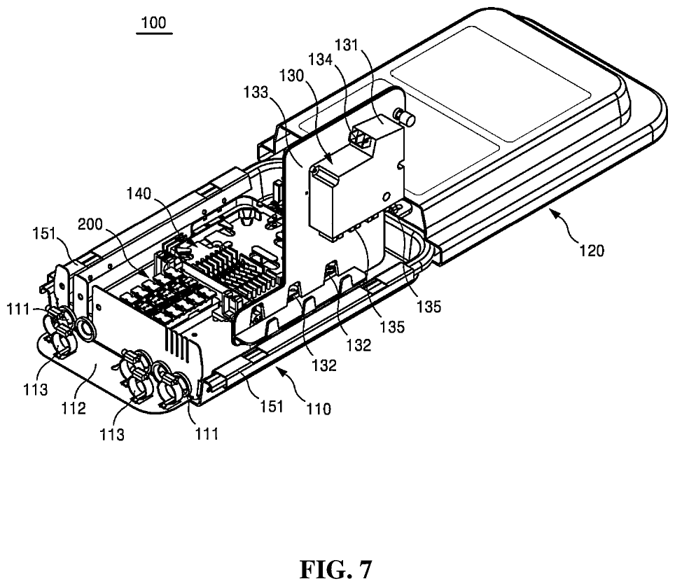

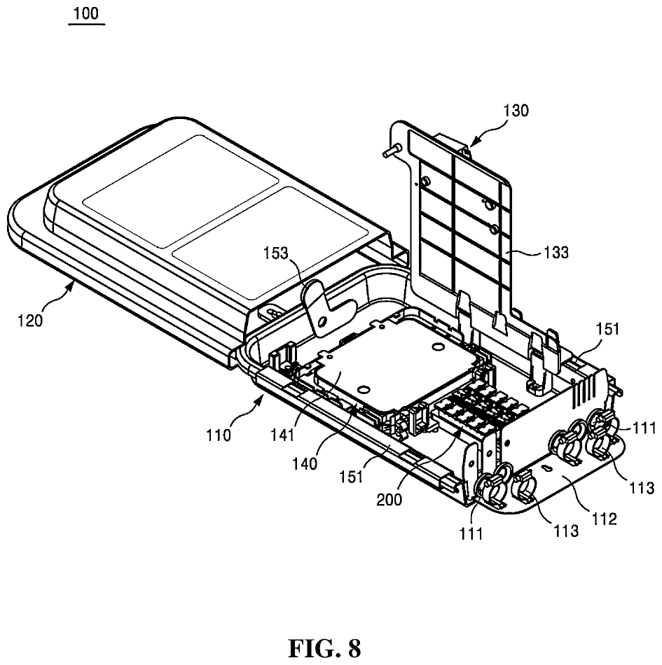

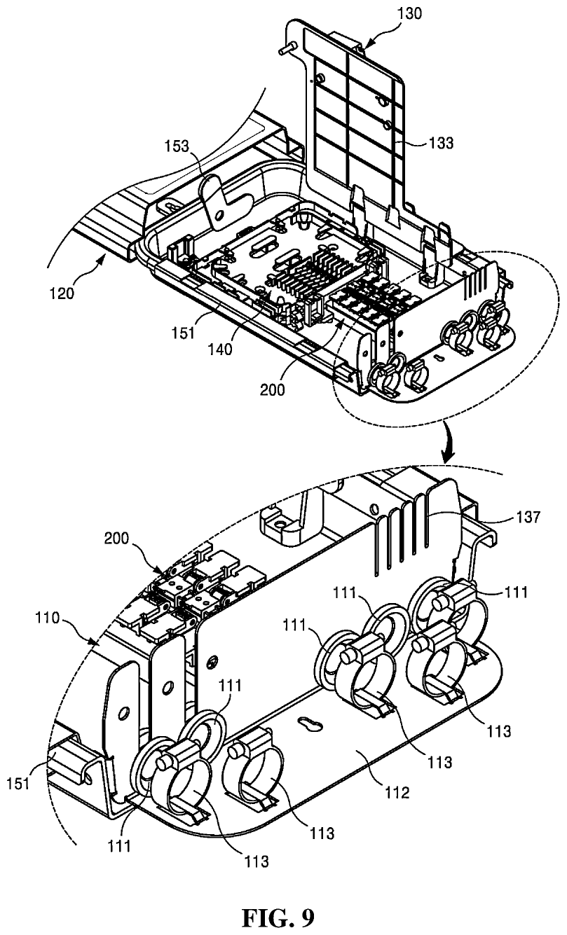

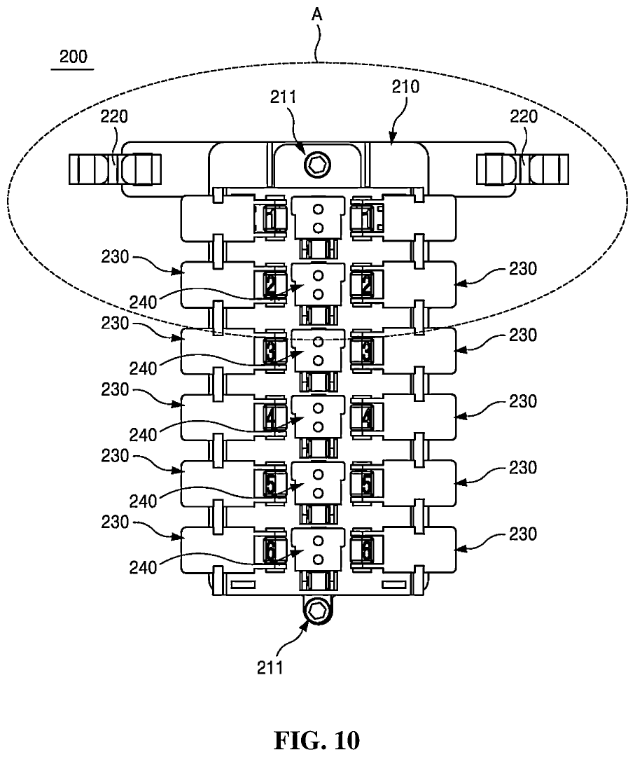

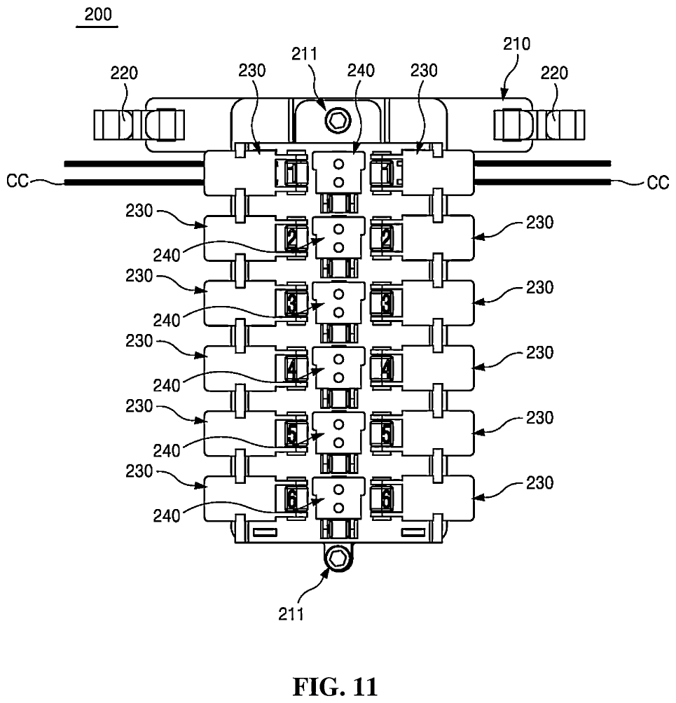

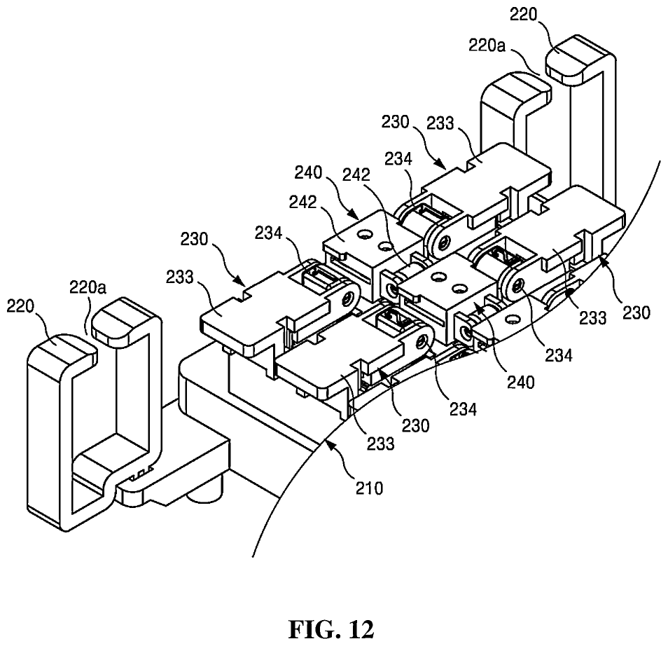

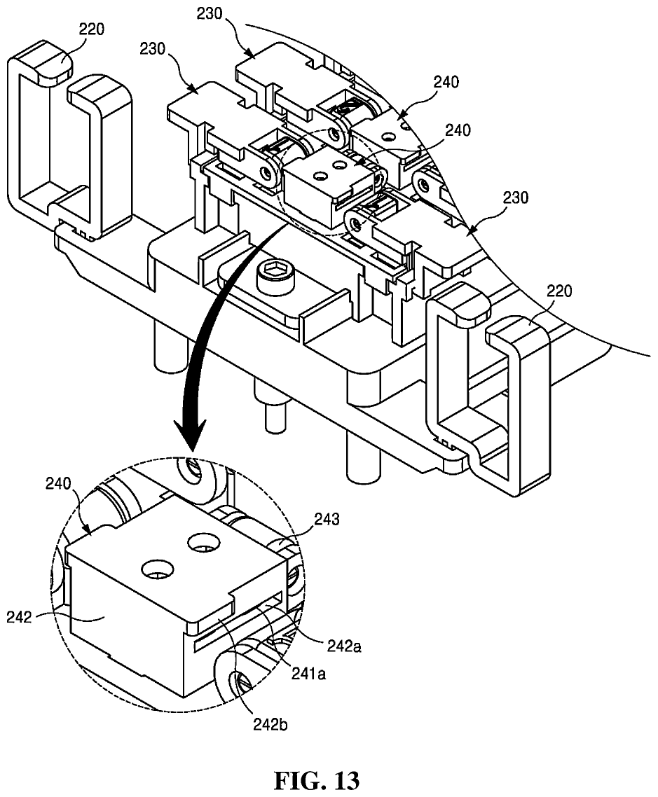

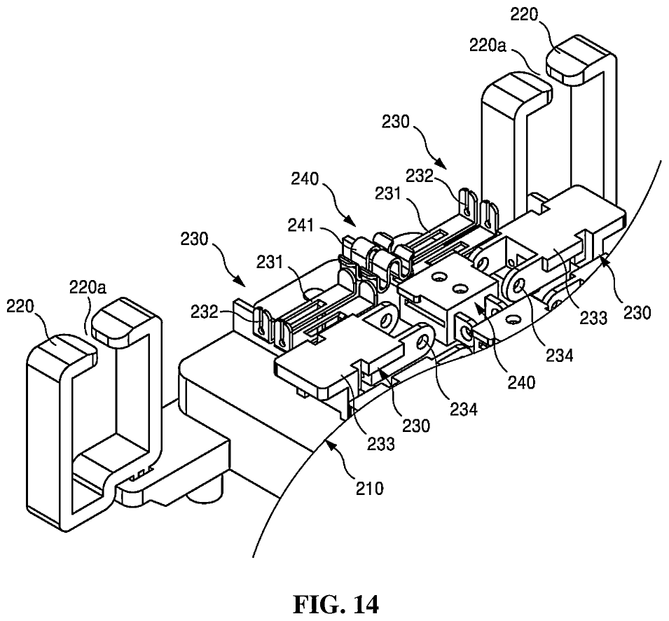

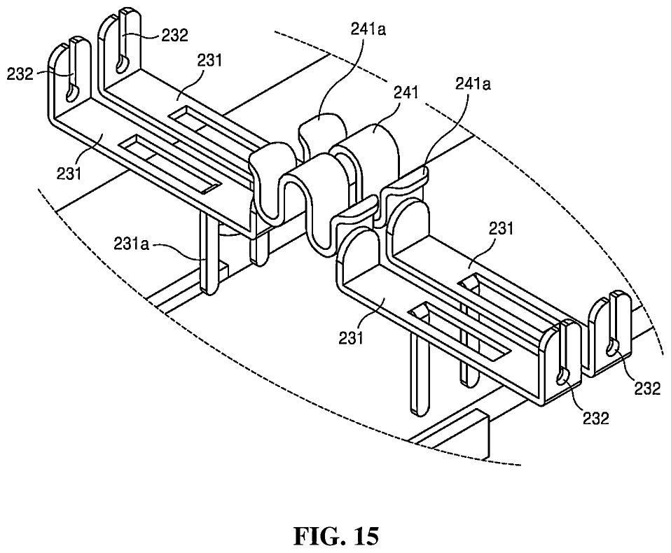

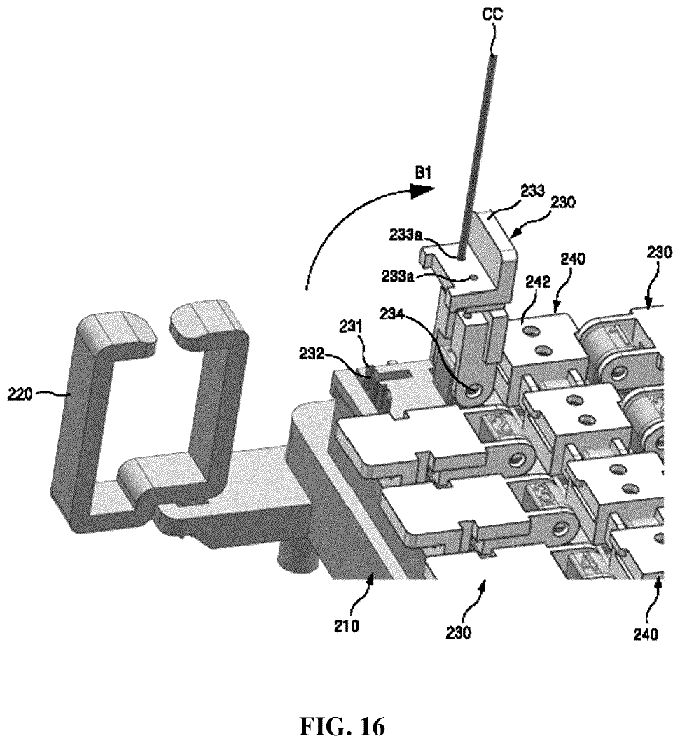

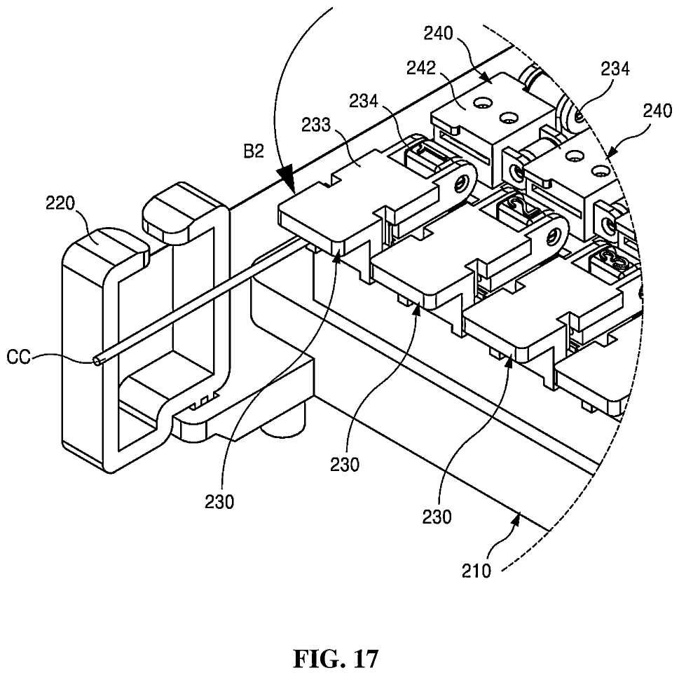

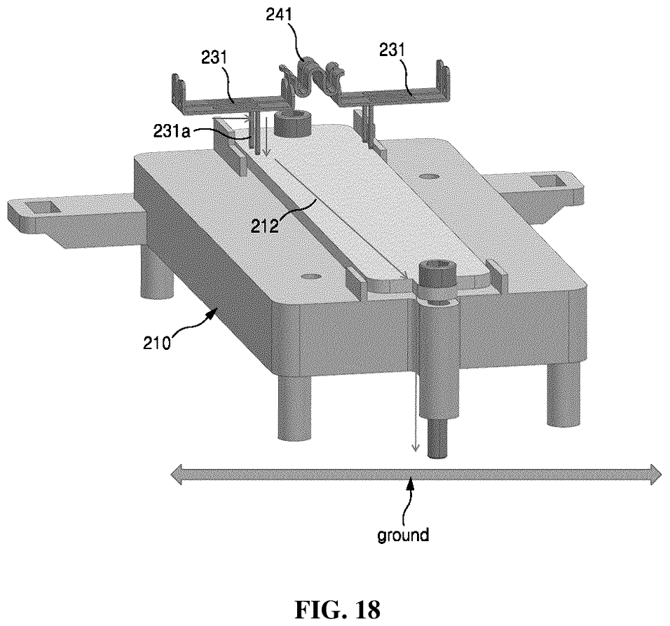

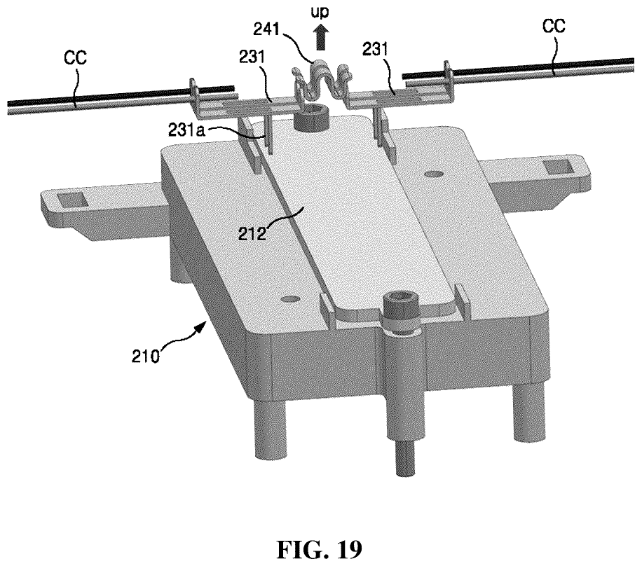

FIG. 3 is a front view of an optical and copper composite terminal box according to an embodiment of the present invention, FIG. 4 is a rear view of FIG. 3, FIG. 5 is a view in which a slide cover in FIG. 3 is opened, FIG. 6 is a rear perspective view of FIG. 5, FIG. 7 is a perspective view in which a splitter mounting plate in FIG. 5 is rotated, FIG. 8 is a view of FIG. 7 from another angle, FIG. 9 is an enlarged view of a main part of FIG. 8, FIG. 10 is a front view of a copper cable connection device, FIG. 11 is a view in which copper cables in FIG. 10 are connected, FIG. 12 is an enlarged perspective view of region A of FIG. 10, FIG. 13 is a rear view of FIG. 12, FIG. 14 is a view in which a copper cable holder and a disconnection part case in FIG. 12 are removed, FIG. 15 is a layout diagram of copper cable connection terminals and disconnection part terminals, FIGS. 16 and 17 are views illustrating a process of connecting a copper cable to a copper cable connection device, FIG. 18 is a view illustrating a grounding structure of the copper cable connection device, and FIG. 19 is a view illustrating a state in which a copper cable connection terminal and a disconnection part terminal are disconnected.

As illustrated in these drawings, an optical and copper composite terminal box 100 is any one of the plurality of optical and copper composite terminal boxes 100-1 and 100-2 illustrated in FIG. 1. Each of the plurality of optical and copper composite terminal boxes 100-1 and 100-2 has the same structure. The optical and copper composite terminal box 100 includes a terminal box body 110 and a slide cover 120.

The terminal box body 110 includes all components except for the slide cover 120. In particular, a splitter 130 and a copper cable connection device 200 are provided in the terminal box body 110. Therefore, it is possible to reduce the occurrence of loss related to construction cost or workability.

Prior to the description of the splitter 130 and the copper cable connection device 200, a structure of the terminal box body 110 will be described.

The terminal box body 110 is a structure having substantially a box shape with an open top. A conventional terminal box is usually made of a plastic material. Therefore, when a long period of time has elapsed since the installation of the terminal box, the plastic is aged due to ultraviolet rays, and the product may be deformed and damaged. However, the optical and copper composite terminal box 100 of the present embodiment may be made of an aluminum material. The optical and copper composite terminal box 100 made of an aluminum material has advantages of being superior in durability to the plastic material and having no problem with environmental regulations.

A plurality of cable lead-in parts 111 through which optical and copper cables enter are provided on a sidewall of the terminal box body 110. For example, the cable lead-in parts 111 are ports through which optical cables C1 and C2 enter as illustrated in FIG. 3. The number of cable lead-in parts 111 may vary to any extent beyond what is illustrated in the drawings. Therefore, the scope of the present invention is not limited by the shape illustrated in the drawings. A packing (not illustrated) may be interposed in an opening of the cable lead-in part 111 to prevent penetration of external dust, moisture, or the like.

A plurality of cable holders 113 that support the optical and copper cables that enter through the cable lead-in part 111 are provided on a peripheral support part 112 of the cable lead-in part 111. The cable holder 113 is a fixing and clamping means for preventing the optical cable C1 from being separated from the cable lead-in part 111 due to an external shock or the like. That is, the cable holder 113 fixes the optical cable C1 to maintain a state in which the optical cable C1 has entered through the cable lead-in part 111. The cable holder 113 is provided to be tightened in a cable tie manner. Therefore, the cable holder 113 is applicable to cables with various thicknesses.

A terminal box fixing member 114 is provided on a rear surface of the terminal box body 110. A plurality of terminal box fixing members 114 are provided for each position. A fixing hole 114a is formed in any one terminal box fixing member 114 among the plurality of terminal box fixing members 114. The fixing hole 114a is a means for hanging the product or assembling the product with a screw.

Prior to the description of the splitter 130 and the copper cable connection device 200, a structure, a role and function of the slide cover 120 will be first described.

The slide cover 120 is slidably coupled to the terminal box body 110 to be opened or closed and cover the splitter 130 and the copper cable connection device 200. That is, the slide cover 120 may close the inside of the terminal box body 110 to protect components as illustrated in FIGS. 3 and 4, and may open the inside of the terminal box body 110 as illustrated in FIGS. 5 to 8. The slide cover 120 may also be made of an aluminum material like the terminal box body 110.

Slide guide rails 151 are provided so that the slide cover 120 can perform a sliding operation with respect to the terminal box body 110. The slide guide rails 151 are provided on both side surfaces of the terminal box body 110 and stably guide the sliding operation of the slide cover 120.

For reference, the conventional terminal box (not illustrated) did not include a component corresponding to a rotatable cover support 153 of the present invention. In the related art, since a cover (not illustrated) is opened or closed left and right in a terminal box body (not illustrated), the terminal box or components in the terminal box are often easily damaged. However, in the case of the present embodiment, since the slide cover 120 can be separated from the terminal box body 110 in a sliding manner, a problem that the optical and copper composite terminal box or the components inside the optical and copper composite terminal box are easily damaged due to the left-right opening or closing can be solved.

Meanwhile, when the slide cover 120 is opened as illustrated in FIGS. 5 to 8 for working in the terminal box body 110, it is difficult when the open slide cover 120 is arbitrarily closed. In order to prevent this, the rotatable cover support 153 is provided in the optical and copper composite terminal box 100 of the present embodiment. The rotatable cover support 153 is rotatably coupled to the terminal box body 110 and supports an opened state of the slide cover 120.

The rotatable cover support 153 may rotate on the sidewall of the terminal box body 110. An operator may rotate the rotatable cover support 153 by manipulating the rotatable cover support 153 by hand. The rotatable cover support 153 may prevent the slide cover 120 from arbitrarily coming down to the terminal box body 110, that is, from being arbitrarily closed. On other words, when the slide cover 120 is opened, the operator may prevent the slide cover 120 from arbitrarily coming down to the terminal box body 110 by turning the rotatable cover support 153 upward.

Meanwhile, the splitter 130 is a device connectable to the optical cable C1 to distribute a signal transmitted through the optical cable C1 to two or more reception devices. The splitter 130 includes a lead-in terminal 134 that can be connected to any one core (e.g., MC1) of a plurality of cores MC1 to MC6 included in the optical cable C1, and a plurality of output terminals 135 that can be connected to a plurality of cables. Each of the plurality of cables may be a patch cord or a drop cable.

As described above, the splitter 130 may split one light beam into several light beams. That is, the splitter 130 may receive one optical cable C1 and output a plurality of cables (e.g., OF1-1 in FIG. 5). Since the splitter 130 is a well-known technology, a detailed internal structure will be omitted.

In order to connect any one core (e.g., MC1) of the plurality of cores MC1 to MC6 included in the optical cable C1 to the lead-in terminal 134 of the splitter 130, a connector may be connected to an end part of the core MC1. Since the connector is connected to the end part of the core MC1, the core MC1 may be connected to the lead-in terminal 134 of the splitter 130.

A plurality of cables OF1-1 may be connected to the plurality of output terminals 135 of the splitter 130. Although only one cable OF1-1 is illustrated in FIG. 5, more cables may be connected to the plurality of output terminals 135 of the splitter 130 in some embodiments.

The cable OF1-1 may be a patch cord or a drop cable. The cable OF1-1 is an optical cable used for direct connection to a house H1, H2, or Hn or a building B1, B2, or Bm. The patch cord OF1-1 may be called one of various terms such as a jumper cord, optical fiber, and the like.

A difference between the patch cord OF1-1 and the optical cable C1 is that the thicknesses of lines are different. Further, the patch cord OF1-1 is flexible, whereas the optical cable C1 is hard. The optical cable C1 is used to connect the optical and copper composite terminal boxes 100-1 and 100-2 to each other. However, the patch cord OF1-1 is directly connected to the house H1, H2, or Hn or the building B1, B2, or Bm. One end of the patch cord OF1-1 may be connected to an output terminal 135 of the splitter 130, and the other end of the patch cord OF1-1 may be connected to communication equipment implemented inside the house H1, H2, or Hn or the building B1, B2, or Bm.

One end of the patch cord OF1-1 is connected to an output terminal 135 of the splitter 130, and the lead-in terminal 134 of the splitter 130 is connected to any one core (e.g., MC1) of the plurality of cores MC1 to MC6 included in the optical cable C1. Since the optical cable C1 and the patch cord OF1-1 are connected to each other by the splitter 130, the data transmitted through the optical cable C1 may be transmitted to the house H1, H2, or Hn or the building B1, B2, or Bm through the patch cord OF1-1.

The cable OF1-1 connected to the output terminal 135 of the splitter 130 may be exposed to the outside through a fixing clip 137 implemented in the terminal box body 110. The fixing clip 137 is a means for fixing the patch cord OF1-1 in order to stably expose the cable OF1-1 to the outside. The fixing clip 137 includes a plurality of grooves.

The splitter 130 is installed in a splitter case 131. The splitter case 131 is mounted on a splitter mounting plate 133 that rotates the splitter case 131 by the action of a hinge 132. The splitter mounting plate 133 may rotate due to the hinge 132. Therefore, there is no risk of loss of parts, and workability is improved.

A fusion splicing tray 140 is provided in the terminal box body 110 at a position corresponding to the splitter mounting plate 133. In the fusion splicing tray 140, the cables C1 and C2 that another core (e.g., MC2) of the plurality of cores MC1 to MC6 included in the optical cable C1 is fused to any one core (not illustrated) of a plurality of cores (not illustrated) included in another optical cable C2 are stored.

In some embodiments, one or more cores (e.g., MC2 to MC6) of the plurality of cores MC1 to MC6 included in the optical cable C1 may be each fused to one of one or more cores (not illustrated) of the plurality of cores (not illustrated) included in another optical cable C2. Since one or more cores (e.g., MC2 to MC6) of the plurality of cores MC1 to MC6 included in the optical cable C1 are each fused to one of one or more cores (not illustrated) of the plurality of cores (not illustrated) included in another optical cable C2, one cable C1 or C2 is generated. One cable C1 or C2 includes a part of a first cable C1 and a part of a second cable C2.

Any one core (e.g., MC1) of the plurality of cores MC1 to MC6 included in the optical cable C1 may be connected to the lead-in terminal 134 of the splitter 130, and the remaining cores (e.g., MC2 to MC6) may be fused to the remaining cores of another optical cable (e.g., C2).

The fusion splicing tray 140 is used to store the fused cables C1 and C2. The terminal box body 110 may further include a tray cover 141 to protect the fused cables C1 and C2 stored in the fusion splicing tray 140.

Another optical cable C2 may be output through an output port. In terms of data transmission, the components are called the cable lead-in part 111 and the output port in the sense that data enters through the optical cable C1 and the data that has entered is transmitted to another place through the optical cable C2, but the cable lead-in part 111 may be called a port or an output port. Similarly, the output port 1100 may be called a port or a lead-in port. On other words, one of a plurality of cable lead-in parts 111 may serve as a lead-in part and the other may serve as an output part.

Meanwhile, the copper cable connection device 200 is a means disposed in the terminal box body 110 adjacent to the splitter 130 that enables connection with a copper (Cu) cable (CC) forming a different signal from the optical cable C1. When there is no copper cable connection device 200, a terminal box that performs a function of the copper cable connection device 200 should be separately manufactured and installed as in the past.

However, in the case of the present embodiment, since the copper cable connection device 200 is provided together with the splitter 130 in the terminal box body 110, the copper cable connection device 200 can be commonly applied.

Referring mainly to FIGS. 10 to 19, the copper cable connection device 200 may include a device body 210, copper cable connection parts 230, and copper cable disconnection parts 240.

The device body 210 is an exterior structure of the copper cable connection device 200. A plurality of copper cable connection parts 230 and a plurality of copper cable disconnection parts 240 are provided on the device body 210 for each position.

An assembly part 211 that can be assembled to the terminal box body 110 is formed in the device body 210 so that the device body 210 can be coupled and assembled to the terminal box body 110.

The copper cable connection device 200 may be easily installed by being fastened with a screw and assembled to the device body 210 using the assembly part 211. Therefore, in areas where the copper cable connection device 200 is not used, the copper cable connection device 200 may be removed from the device body 210.

A copper cable arrangement guide 220 which is coupled to one side of the device body 210 and guides the arrangement of copper cables CC is provided.

The copper cable arrangement guide 220 has an annular shape with an opening 220a formed at one side thereof. Therefore, when the copper cable CC is pushed into the copper cable arrangement guide 220 through the opening 220a, the copper cables CC are arranged well without being scattered around or being twisted with each other.

In the present embodiment, the device body 210 is provided to be grounded as illustrated in FIG. 18. Therefore, when a stroke of lightning or an abnormal current occurs, the current may be grounded to the road surface, and thus a risk of product damage may be eliminated. The stroke of lightning or abnormal current may be grounded to pass through the ground plate 212 of the device body 210 through a bridge 231a of the copper cable connection terminal 231 of the copper cable connection part 230. Therefore, the ground plate 212 made of a material through which current flows is embedded in the device body 210, and the bridge 231a of the copper cable connection terminal 231 is provided to be in contact with the ground plate 212.

The copper cable connection part 230 is provided in the device body 210 and forms a place where a plurality of copper cables CC are connected at different positions. Two copper cables CC may be connected to one copper cable connection part 230. Of course, one copper cable CC may be connected to one copper cable connection part 230, or three or more copper cables CC may be connected to one copper cable connection part 230.

Further, two copper cable connection parts 230 are used as a set for each copper cable disconnection part 240. In the present embodiment, 12 copper cable connection parts 230 and 6 copper cable disconnection parts 240 are provided. However, this is only one example, and the scope of the present invention is not limited to these numbers.

The copper cable connection part 230 may include a copper cable connection terminal 231, a copper cable holder 233, and a holder hinge 234.

The copper cable connection terminal 231 is made of a conductive material, for example, a copper material. A terminal groove 232 into which the copper cable CC is inserted is formed in the copper cable connection terminal 231. In the present embodiment, two terminal grooves 232 are formed in the copper cable connection terminal 231.

As described above, the bridge 231a is formed in the copper cable connection terminal 231. The bridges 231a are provided to be equal in number to the terminal grooves 232, and are electrically connected to the ground plate 212 in the device body 210 to perform a grounding function.

The copper cable holder 233 is a means which is rotatably coupled to the device body 210 and guides the copper cable CC to be positioned in the terminal groove 232 of the copper cable connection terminal 231. The copper cable holder 233 is an injection product.

Copper cable insertion grooves 233a into which the copper cables CC can be inserted are formed in the copper cable holder 233. The copper cable insertion grooves 233a are provided to be equal in number to the terminal grooves 232. In this case, there is no need to peel off outer sheaths of the copper cables CC inserted into the copper cable insertion grooves 233a.

The holder hinge 234 is connected to the copper cable holder 233 and the device body 210, and serves to guide the rotation of the copper cable holder 233.

Accordingly, after the copper cable holder 233 is pushed in a B1 direction as illustrated in FIG. 16, the copper cable CC is inserted into the copper cable insertion groove 233a of the copper cable holder 233. In this case, it is not necessary to peel off the outer sheath of the copper cable CC. Then, as illustrated in FIG. 17, the copper cable holder 233 is pressed in a B2 direction. Then, while the copper cable CC is positioned in the terminal groove 232 of the copper cable connection terminal 231, the copper cable CC may be conducted, that is, may be connected. As described above, in the present embodiment, the connection work of the copper cable CC is also easily performed.

The copper cable disconnection part 240 is disposed between the copper cable connection parts 230 and serves to connect between the copper cables CC or disconnect the connection between the copper cables CC.

One copper cable disconnection part 240 is disposed between two copper cable connection parts 230, and the copper cable disconnection part 240 and the two copper cable connection parts 230 are used as a set. The copper cable disconnection part 240 may include a disconnection part terminal 241, a disconnection part case 242, and a disconnection part hinge 243.

The disconnection part terminal 241 is a means that has a non-linear shape and is capable of selectively connecting or disconnecting with the copper cable connection terminal 231 at both sides thereof. Like the copper cable connection terminal 231, the disconnection part terminal 241 may be made of, for example, a copper material. Since the disconnection part terminal 241 should be selectively conducted between the copper cable connection terminals 231 at both sides thereof, the disconnection part terminal 241 may be manufactured in a non-linear shape, for example, a crown shape.

As described above, since the disconnection part terminal 241 is manufactured in, for example, the crown shape and disposed between the copper cable connection terminals 231, there is no need for separate fusion between the copper cable connection terminals 231. That is, the disconnection part terminal 241 has a structure in which the copper cable connection terminal 231 to which the copper cable CC is connected is brought into contact with the disconnection part terminal 241 of the crown structure so that current flows therethrough. Therefore, there is no need to connect the copper cables CC to each other as in the past.

The effect of the action of the disconnection part terminal 241 will be further described. In FIG. 19, for example, when one copper cable CC is for a carrier and the other is for a subscriber, it is only necessary to connect the carrier copper cable CC and the subscriber copper cable CC during the contract. However, when the contract is canceled or the use is suspended, it is necessary to disconnect the carrier copper cable CC and the subscriber copper cable CC, but in this case, there is no need to remove the carrier copper cable CC. In this case, as illustrated in FIG. 19, it is sufficient to lift the disconnection part terminal 241 and separate the disconnection part terminal 241 from the copper cable connection terminal 231.

Further, even when the carrier copper cable CC and the subscriber copper cable CC are intended to be connected to each other, it is impossible to check which cable is the carrier copper cable CC or the subscriber copper cable CC with the naked eye. However, unlike the subscriber copper cable CC, since constant noise is generated in the carrier copper cable CC, the corresponding cable may be checked through this noise, and it is sufficient to insert and connect the subscriber copper cable CC as necessary.

The disconnection part case 242 is connected to the disconnection part terminal 241 and forms one body with the disconnection part terminal 241. In order for the disconnection part case 242 to form one body with the disconnection part terminal 241, a terminal hanger 242a is provided in the form of a hole in the disconnection part case 242. Further, an end region of a wing flange 241a of the disconnection part terminal 241 may be hung and supported by the terminal hanger 242a of the disconnection part case 242.

Further, in order to forcibly release, that is, disconnect, the connection with the disconnection part terminal 241 by raising the copper cable connection terminal 231 as illustrated by an arrow in FIG. 19, the disconnection part case 242 needs to be pulled and rotated. In order to conveniently perform the above operation, handle parts 242b for handling the disconnection part case 242 are provided at both sides of the disconnection part case 242. Therefore, the operation for releasing the connection between the terminals may be easily performed without a separate tool.

The disconnection part hinge 243 is a means which is connected to the disconnection part case 242 and the device body 210 and guides the rotation of the disconnection part case 242.

Accordingly, when the disconnection part case 242 is pressed downward, the disconnection part terminal 241 formed as one body with the disconnection part case 242 is moved down, and thus the copper cable connection terminal 231 and the disconnection part terminal 241 communicate with each other so that the corresponding copper cables CC are connected.

Conversely, when the disconnection part case 242 is operated upward by the action of the disconnection part hinge 243, that is, when the disconnection part case 242 is lifted, the disconnection part terminal 241 is moved upward in the direction of the arrow in FIG. 19 so that the connection between the copper cable connection terminal 231 and the disconnection part terminal 241 may be forcibly disconnected. In this case, it is very convenient in that the connection between the copper cables CC can be forcibly released or disconnected without removing the copper cables CC as before.

According to the present embodiment which acts as the structure described above, by implementing the optical terminal box and the copper terminal box that have been individually manufactured and installed as one body, it is possible to reduce the occurrence of loss related to construction cost or workability.

The effects of the present invention will be further described.

First, unlike previous methods, the present invention is a method in which the slide cover 120 slides, and thus it is possible to fix a problem in which the door is opened or closed by wind and causes damage to the terminal box or internal devices, which is a disadvantage of the left-right opening/closing method.

Second, there is an advantage in that an optical cable and a copper cable can be used simultaneously or selectively as needed in one terminal box.

Third, even when the previously installed copper cables CC are not removed, the connection between the copper cables CC can be forcibly released and disconnected, and thus it is possible to conveniently perform the cable release and disconnection work.

Fourth, it is not necessary to peel off outer sheaths of copper cables CC when connecting the copper cables CC, and thus it is possible to conveniently perform the connection between the copper cables CC.

Fifth, since the terminal box grounding is possible, the product can be protected from abnormal current.

Sixth, when connecting optical cables and copper cables, it is possible to easily and simply assemble the optical cables and the copper cables.

Seventh, since an exterior structure is made of an aluminum material, it is semi-permanent and has excellent durability, and thus it can be used without inconvenience of product deformation and damage during installation and operation.

While the present invention has been described with reference to the embodiment illustrated in the accompanying drawings, the embodiment should be considered in a descriptive sense only, and it should be understood by those skilled in the art that various alterations and equivalent other embodiments may be made. Therefore, the scope of the present invention should be defined only by the appended claims.

What is claimed is:

1. An optical and copper composite terminal box comprising:
a terminal box body;
a splitter having a lead-in terminal connectable to any one of a plurality of cores included in an optical cable, and a plurality of output terminals connectable to a plurality of cables, and which is provided on one side in the terminal box body; and
a copper cable connection device which is disposed in the terminal box body adjacent to the splitter and is connectable to a copper cable forming a different signal from the optical cable.

2. The optical and copper composite terminal box of claim 1, further comprising:
a splitter case in which the splitter is installed; and
a splitter mounting plate in which the splitter case is mounted and which rotates the splitter case by an action of a hinge.

3. The optical and copper composite terminal box of claim 1, further comprising a fusion splicing tray which is provided in the terminal box body at a position corresponding to the splitter mounting plate and in which cables that another core of the plurality of cores included in the optical cable is fused to any one core of a plurality of cores included in another optical cable are disposed.

4. The optical and copper composite terminal box of claim 1, further comprising a slide cover which is slidably coupled to the terminal box body to be opened or closed to cover the splitter and the copper cable connection device.

5. The optical and copper composite terminal box of claim 4, further comprising:
slide guide rails which are provided on both side surfaces of the terminal box body and guide a sliding operation of the slide cover; and
a rotatable cover support which is rotatably coupled to the terminal box body and supports an opened state of the slide cover.

6. The optical and copper composite terminal box of claim 1, further comprising:
a plurality of cable lead-in parts which are provided on a sidewall of the terminal box body and through which optical and copper cables enter;
a plurality of cable holders which are provided on a peripheral support part of the cable lead-in parts and support the optical and copper cables that enter through the cable lead-in parts; and
at least one terminal box fixing member provided on a rear surface of the terminal box body.

7. The optical and copper composite terminal box of claim 1, wherein the copper cable connection device includes:
a device body having an assembly part that is allowed to be assembled to the terminal box body;
copper cable connection parts which are provided on the device body and to which a plurality of copper cables are connected at different positions; and
a copper cable disconnection part which is disposed between the copper cable connection parts and connects between the copper cables or disconnects between the copper cables.

8. The optical and copper composite terminal box of claim 7, wherein two copper cable connection parts are used as a set for each copper cable disconnection part, wherein a plurality of copper cable disconnection parts and a plurality of copper cable connection parts are provided on the device body, and
the device body is provided to be grounded.

9. The optical and copper composite terminal box of claim 7, wherein the copper cable connection part includes:
a copper cable connection terminal which is made of a conductive material, and including at least one terminal groove into which a copper cable is inserted;
a copper cable holder including a copper cable insertion groove into which the copper cable is insertable without peeling off an outer sheath thereof and which is rotatably coupled to the device body and guides the copper cable to be positioned in the terminal groove of the copper cable connection terminal; and
a holder hinge which is connected to the copper cable holder and the device body and guides rotation of the copper cable holder.

10. The optical and copper composite terminal box of claim 9, wherein the copper cable disconnection part includes:
a disconnection part terminal which has a non-linear shape and is allowed to selectively connect to or disconnect the copper cable connection terminal at both sides thereof;
a disconnection part case which is connected to the disconnection part terminal to form one body with the disconnection part terminal, and is rotatably coupled to the device body; and
a disconnection part hinge which is connected to the disconnection part case and the device body and guides rotation of the disconnection part case,
wherein, when the disconnection part case is pressed downward, the copper cable connection terminal and the disconnection part terminal communicate with each other so that the corresponding copper cables are connected, and when the disconnection part case is operated upward, the connection between the copper cable connection terminal and the disconnection part terminal is forcibly disconnected.

11. The optical and copper composite terminal box of claim 7, further comprising a copper cable arrangement guide which is coupled to one side of the device body and guides arrangement of the copper cables.
